(19) United States
(12) Patent Application Publication
(10) Pub. No.: US 2026/0049637 A1
(43) Pub. Date: Feb. 19, 2026

(54) BEARING

(71) Applicant: TIEN HSIN INDUSTRIES CO., LTD., Taichung City (TW)

(72) Inventor: WEI-CHIH WEI, Taichung City (TW)

(73) Assignee: TIEN HSIN INDUSTRIES CO., LTD., Taichung City (TW)

(21) Appl. No.: 18/804,213

(22) Filed: Aug. 14, 2024

(51) Int. Cl. F16C 33/38; F16C 19/16; F16C 33/58

(52) U.S. Cl. CPC F16C 33/38; F16C 19/16; F16C 33/583

(57) ABSTRACT

A bearing includes a cage, a plurality of rolling elements, an inner ring, and an outer ring. The cage is an annular structure and has a cutout; the plurality of rolling elements are disposed on the cage; the inner ring includes a plurality of inner ring sections which jointly surround to form the inner ring; the outer ring includes a plurality of outer ring sections which jointly surround to form the outer ring; a containing space is provided between the outer ring and the inner ring, and the cage is located in the containing space. With the cutout of the cage, the cage could be twisted and removed from the containing space for replacement.

### BACKGROUND OF THE INVENTION

### Technical Field

The present disclosure relates generally to a bearing, and more particularly to a bearing which could be quickly installed and disassembled.

### Description of Related Art

Generally, a bearing is an element used to support a rotating shaft, mainly to reduce friction and bear a load of the rotating shaft. The bearing is widely used in a bicycle, a car, an aircraft, a washing machine, a vacuum cleaner, etc. The bearing is a crucial component for maintaining a stable operation of mechanical equipment.

Taking the bicycle as an example, a plurality of bearings installed on the bicycle include a headset bearing, a frame bearing, a pedal bearing, a derailleur bearing, etc. A conventional bearing includes an outer ring, an inner ring, a cage, and a plurality of rolling elements. The outer ring and the inner ring are fitted each other and an accommodation space is formed between the outer ring and the inner ring. The cage is used to fix the rolling elements. The cage and the rolling elements are disposed in the accommodation space, so that the rolling elements could roll between the outer ring and the inner ring, thus reducing friction.

However, if the bearing needs to be replaced after the bearing is installed, other components need to be disassembled before replacing the bearing. Taking the headset bearing as an example, if the headset bearing needs to be replaced, an entire handlebar assembly has to be disassembled from a steering tube before replacing the old headset bearing. When a new headset bearing is installed, the handlebar assembly needs to be re-installed, which is time-consuming and inconvenient.

### BRIEF SUMMARY OF THE INVENTION

In view of the above, the primary objective of the present disclosure is to provide a bearing with a structural design that achieves rapid replacement and installation.

In order to achieve the above objective, the present disclosure provides a bearing, including a cage, a plurality of rolling elements, an inner ring, and an outer ring. The cage is an annular structure and has a cutout; the plurality of rolling elements are disposed on the cage; the inner ring includes a plurality of inner ring sections, wherein the plurality of inner ring sections jointly surround to form the inner ring; the outer ring includes a plurality of outer ring sections, wherein the plurality of outer ring sections jointly surround to form the outer ring; a containing space is provided between the outer ring and the inner ring, and the cage is located in the containing space.

In one embodiment, further including a bearing bowl, wherein the bearing bowl includes an inner bearing bowl and an outer bearing bowl; the inner ring and the outer ring are disposed in an accommodation space which is formed between the inner bearing bowl and the outer bearing bowl.

In one embodiment, wherein an inner wall of the inner bearing bowl abuts against an outer surface of the inner ring; an inner wall of the outer bearing bowl abuts against an outer surface of the outer ring.

In one embodiment, the inner bearing bowl has a recess formed by recessing from an inner wall of the inner bearing bowl.

In one embodiment, the inner bearing bowl is formed integrally.

In one embodiment, the outer bearing bowl is formed integrally.

In one embodiment, a side of the inner ring facing the containing space has an inner annular groove which is in contact with the plurality of rolling elements.

In one embodiment, a side of the outer ring facing the containing space has an outer annular groove which is in contact with the plurality of rolling elements.

In one embodiment, the plurality of inner ring sections include two inner ring sections, and each of the two inner ring sections is semicircular.

In one embodiment, the plurality of outer ring sections include two outer ring sections, and each of the two outer ring sections is semicircular.

With the cage having the cutout, when the cage needs to be replaced due to wear, scratches, damage, etc., it is only required to twist the cage to enlarge the gap between the two ends of the cutout of the cage, so that the cage could be removed from the front fork of the bicycle. In this way, the user could replace the cage without disassembling the handlebar assembly.

### BRIEF DESCRIPTION OF THE SEVERAL VIEWS OF THE DRAWINGS

The present disclosure will be best understood by referring to the following detailed description of some illustrative embodiments in conjunction with the accompanying drawings, in which

FIG. 1 is a perspective view of the bearing according to an embodiment of the present disclosure;

FIG. 2 is an exploded view of the bearing according to the embodiment of the present disclosure;

FIG. 3 is a side view of the bearing according to the embodiment of the present disclosure;

FIG. 4 is a sectional view along the 4-4 line in FIG. 3;

FIG. 5 is a top view of the bearing according to the embodiment of the present disclosure;

FIG. 6 is a sectional view along the 6-6 line in FIG. 5; and

FIG. 7 is a partially enlarged view of a marked region A in FIG. 6.

### DETAILED DESCRIPTION OF THE INVENTION

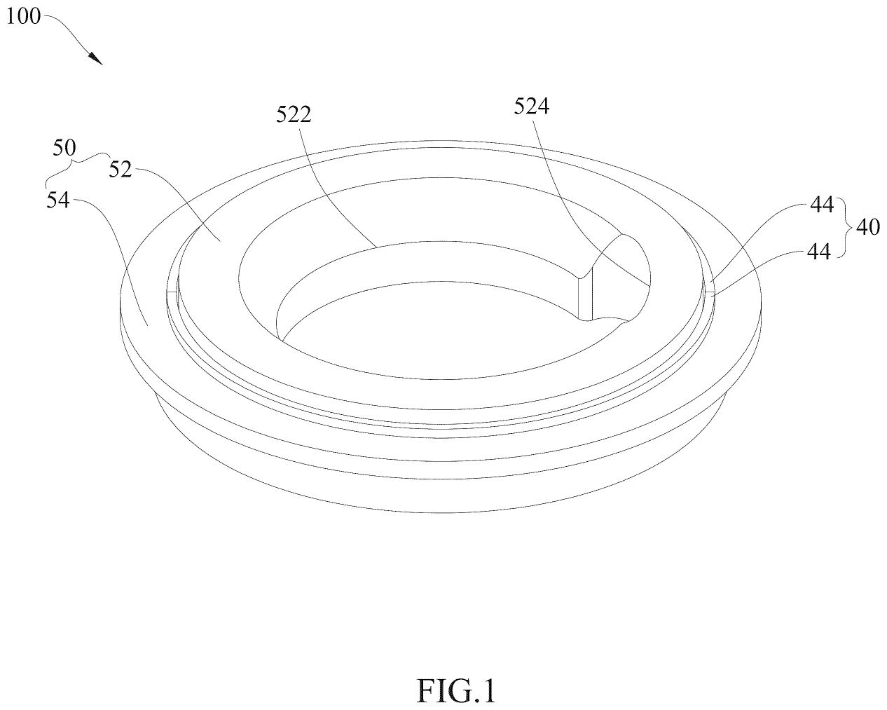

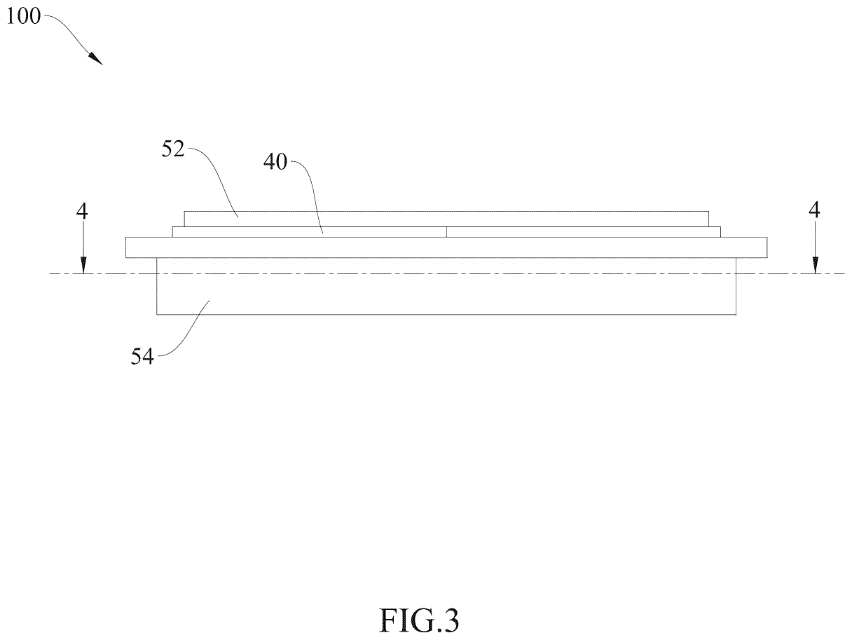

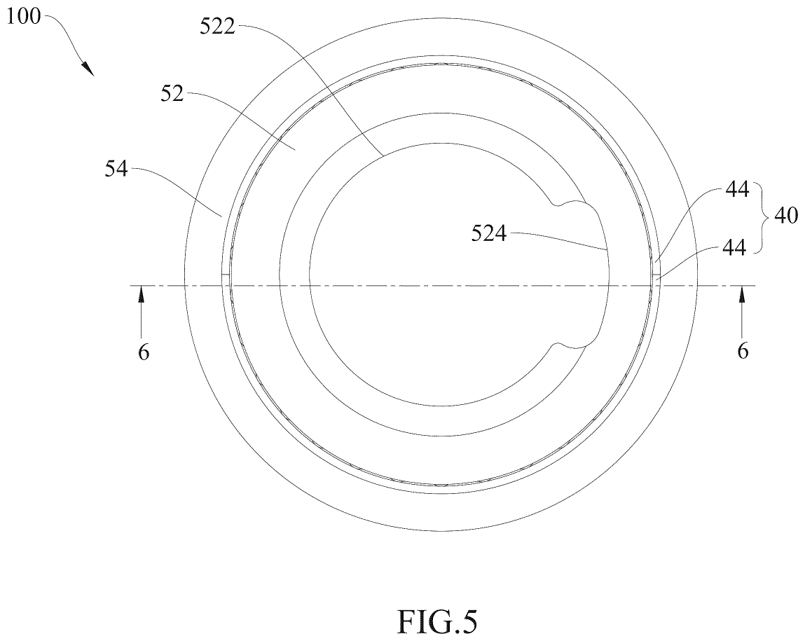

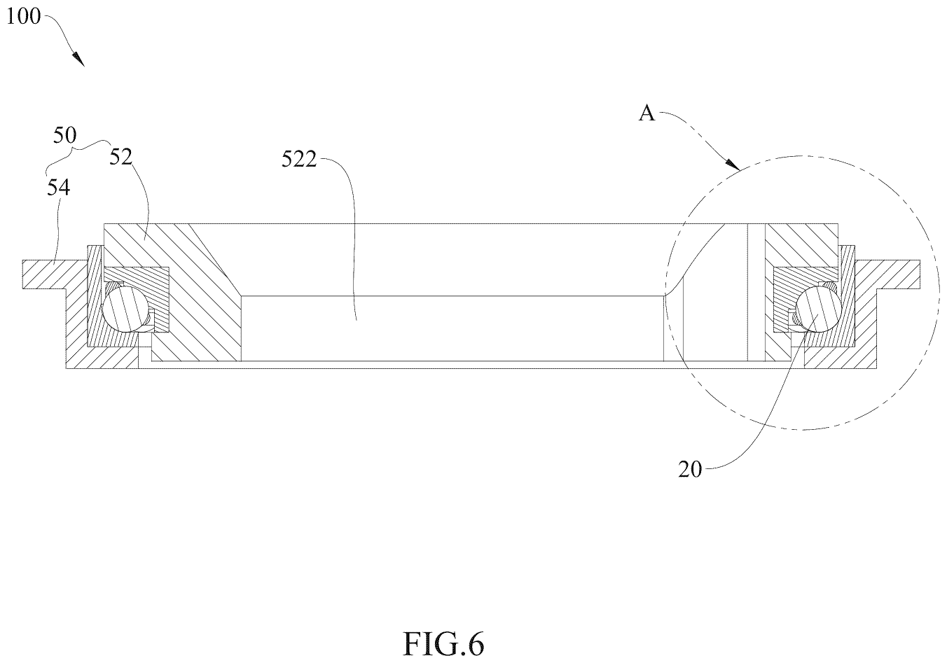

A bearing 100 according to an embodiment of the present disclosure is illustrated in FIG. 1 to FIG. 7. The bearing 100 includes a cage 10, a plurality of rolling elements 20, an inner ring 30, an outer ring 40, and a bearing bowl 50.

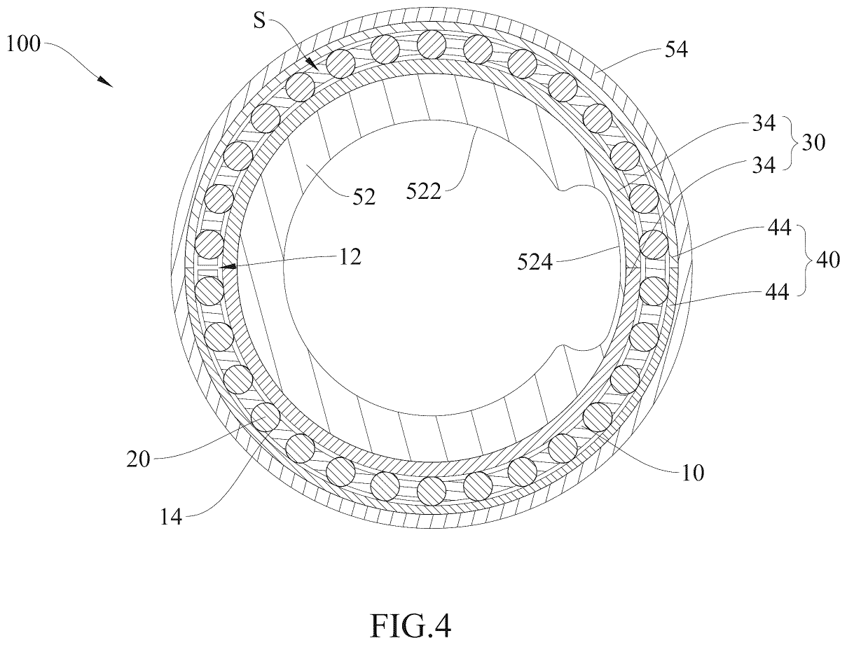

As shown in FIG. 4, the cage 10 is an annular structure. The cage 10 has a cutout 12 and a plurality of rolling element holes 14, wherein a gap is provided between two ends of the cutout 12, and the rolling element holes 14 are disposed at an interval. The rolling elements 20 are respectively disposed on the rolling element holes 14 of the cage 10, and the rolling elements 20 could roll in the rolling element holes 14.

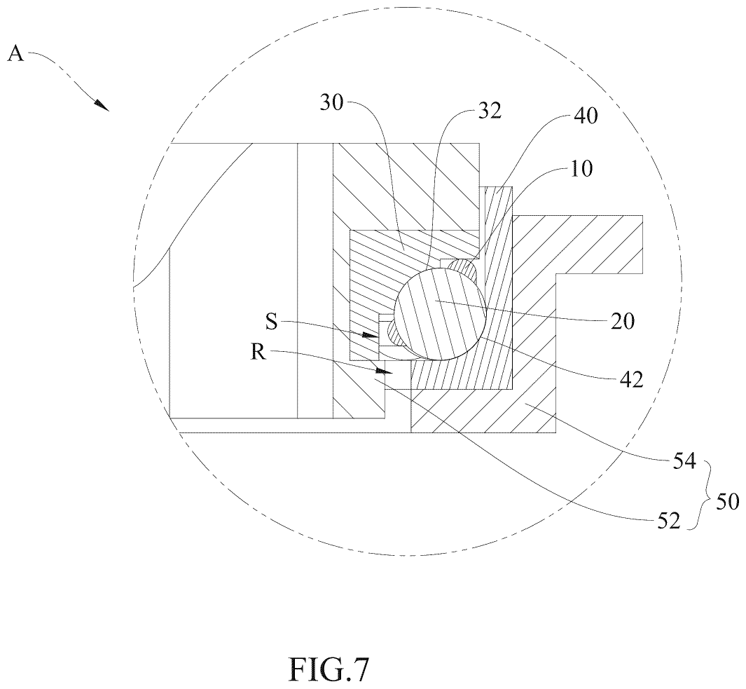

As shown in FIG. 4, the inner ring 30 and the outer ring 40 are annular structures. As shown in FIG. 7, a containing space S is provided between the inner ring 30 and the outer ring 40; the cage 10 is located in the containing space S. A side of the inner ring 30 facing the containing space S has an inner annular groove 32. A surface of the inner annular groove 32 is curved and has a contour matching the rolling elements 20. A side of the outer ring 40 facing the containing space S has an outer annular groove 42. A surface of the outer annular groove 42 is curved and has a contour matching the rolling elements 20. In this way, the inner annular groove 32 and the outer annular groove 42 cooperate to form an annular groove having a contour matching the rolling elements 20. Thereby, the rolling elements 20 are in contact with the inner annular groove 32 and the outer annular groove 42 and could smoothly move relative to the inner annular groove 32 and the outer annular groove 42.

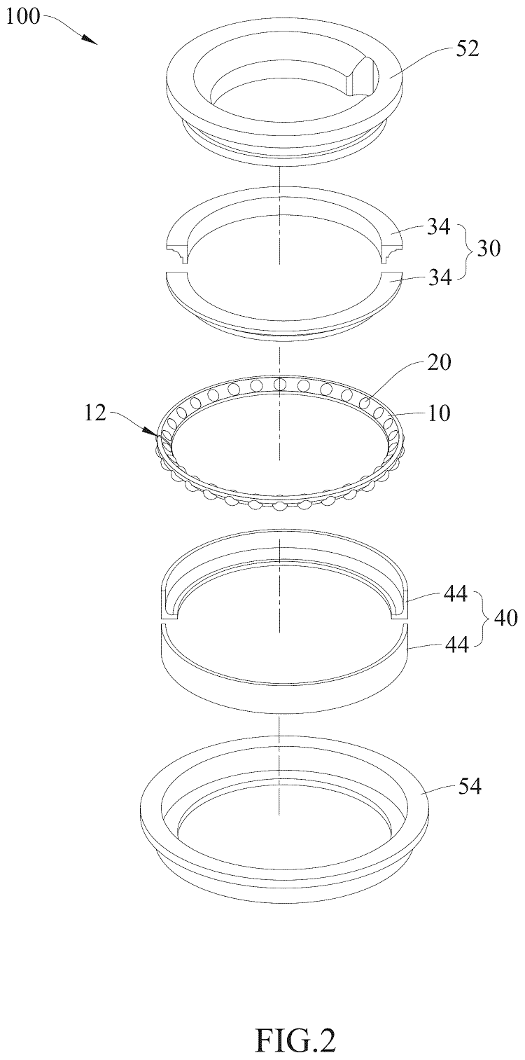

As shown in FIG. 4, the inner ring 30 includes a plurality of inner ring sections 34, wherein the inner ring sections 34 jointly surround to form the inner ring 30. In the current embodiment, a number of the inner ring sections 34 is two, and each of the two inner ring sections is semicircular. The two inner ring sections 34 cooperate to form an annular structure (as shown in FIG. 2). In this way, when one of the inner ring sections 34 needs replacement, only the inner ring section 34 needs to be replaced without replacing the entire inner ring 30. In other embodiments, the number of the inner ring sections 34 might be more than two; for example, the number of the inner ring sections 34 could be three, and the three inner ring sections could also achieve the objective of jointly surrounding to form the inner ring 30 and facilitating the replacement.

As shown in FIG. 4, the outer ring 40 includes a plurality of outer ring sections 44, wherein the outer ring sections 44 jointly surround to form the outer ring 40. In the current embodiment, a number of the outer ring sections 44 is two, and each of the two outer ring sections 44 is semicircular. The two outer ring sections 44 cooperate to form an annular structure (as shown in FIG. 2). In this way, when one of the outer ring sections 44 needs replacement, only the outer ring section 44 needs to be replaced without replacing the entire outer ring 40. In other embodiments, the number of the outer ring sections 44 might be more than two; for example, the number of the outer ring sections 44 could be three, and the three outer ring sections 44 jointly surround to form the outer ring 40. It is worth mentioning that, the aforementioned inner ring sections 34 and the aforementioned outer ring sections 44 could be in different quantities according to demand. For example, three inner ring sections 34 jointly surround to form the inner ring 30 while four outer ring sections 44 jointly surround to form the outer ring 40.

As shown in FIG. 7, the bearing bowl 50 includes an inner bearing bowl 52 and an outer bearing bowl 54. An accommodation space R is provided between the inner bearing bowl 52 and the outer bearing bowl 54. The inner ring 30 and the outer ring 40 are disposed in the accommodation space R. In the current embodiment, the inner bearing bowl 52 has an axial hole 522 and a recess 524. The axial hole 522 penetrates the inner bearing bowl 52 and is for a front fork of a bicycle to insert. The recess 524 is formed by recessing from an inner wall of the inner bearing bowl 52 and communicates with the axial hole 522. In this way, when the front fork of the bicycle is inserted into the axial hole 522, the recess 524 allows wires of the bicycle to pass through, thereby providing a better appearance and reducing the cracking phenomenon due to the exposure of the wires which extends the lifespan of the wires.

The inner bearing bowl 52 is formed integrally. An inner wall of the inner bearing bowl 52 abuts against an outer surface of the inner ring 30. The inner bearing bowl 52 and the inner ring 30 are stuck to each other. The outer bearing bowl 54 is formed integrally. An inner wall of the outer bearing bowl 54 abuts against an outer surface of the outer ring 40. The outer bearing bowl 54 and the outer ring 40 are stuck to each other. In this way, when the inner bearing bowl 52 and the outer bearing bowl 54 are separated relative to each other, the inner ring 30 and the outer ring 40 could be separated relative to each other along with the inner bearing bowl 52 and outer bearing bowl 54; in other words, the inner ring 30 and the outer ring 40 are securely positioned in the inner bearing bowl 52 and the outer bearing bowl 54 respectively without being easily detached. Therefore, the aforementioned structure could avoid the problem that during disassembling the bearing 100, the inner ring 30 or the outer ring 40 generates a displacement or misalignment which causes the inner ring 30, the outer ring 40, and the rolling elements 20 to rotate roughly.

In summary, with the cage 10 having the cutout 12 design, when the bearing 100 or the cage 10 need replacement or inspection, a user could separate the inner bearing bowl 52 and the outer bearing bowl 54, and keep the inner bearing bowl 52 and the outer bearing bowl 54 on the front fork of the bicycle; then the user could disassemble the inner ring 30 and twist the cage 10, so that the gap between the two ends of the cutout 12 of the cage 10 becomes larger and the cutout 12 could pass through the front fork and be removed from the front fork; finally the user could disassemble the outer ring 40. In this way, the user could replace the bearing 100 or the cage 10 without disassembling a handlebar assembly, thereby achieving the objective of rapid replacement of the bearing 100 or the cage 10.

It must be pointed out that the embodiments described above are only some preferred embodiments of the present disclosure. All equivalent structures which employ the concepts disclosed in this specification and the appended claims should fall within the scope of the present disclosure.

What is claimed is:

1. A bearing, comprising:
a cage being an annular structure and having a cutout;
a plurality of rolling elements disposed on the cage;
an inner ring comprising a plurality of inner ring sections, wherein the plurality of inner ring sections jointly surround to form the inner ring; and
an outer ring comprising a plurality of outer ring sections, wherein the plurality of outer ring sections jointly surround to form the outer ring; a containing space is provided between the outer ring and the inner ring, and the cage is located in the containing space.

2. The bearing as claimed in claim 1, further comprising a bearing bowl, wherein the bearing bowl comprises an inner bearing bowl and an outer bearing bowl; the inner ring and the outer ring are disposed in an accommodation space which is formed between the inner bearing bowl and the outer bearing bowl.

3. The bearing as claimed in claim 2, wherein an inner wall of the inner bearing bowl abuts against an outer surface of the inner ring; an inner wall of the outer bearing bowl abuts against an outer surface of the outer ring.

4. The bearing as claimed in claim 2, wherein the inner bearing bowl has a recess formed by recessing from an inner wall of the inner bearing bowl.

5. The bearing as claimed in claim 2, wherein the inner bearing bowl is formed integrally.

6. The bearing as claimed in claim 2, wherein the outer bearing bowl is formed integrally.

7. The bearing as claimed in claim 1, wherein a side of the inner ring facing the containing space has an inner annular groove which is in contact with the plurality of rolling elements.

8. The bearing as claimed in claim 1, wherein a side of the outer ring facing the containing space has an outer annular groove which is in contact with the plurality of rolling elements.

9. The bearing as claimed in claim 1, wherein the plurality of inner ring sections comprise two inner ring sections, and each of the two inner ring sections is semicircular.

10. The bearing as claimed in claim 1, wherein the plurality of outer ring sections comprise two outer ring sections, and each of the two outer ring sections is semicircular.
